(19) United States
(12) Patent Application Publication
(10) Pub. No.: US 2018/0117743 A1
(43) Pub. Date: May 3, 2018

(54) Rotational Tool Bit

(71) Applicant: Daniel L. Pinckard, Tualatin, OR (US)

(72) Inventor: Daniel L. Pinckard, Tualatin, OR (US)

(21) Appl. No.: 15/856,415

(22) Filed: Dec. 28, 2017

Related U.S. Application Data
(63) Continuation-in-part of application No. 14/624,843, filed on Feb. 18, 2015.

(51) Int. Cl. B25B 15/00; B25F 1/04

(52) U.S. Cl. CPC B25B 15/005; B25F 1/04

(57) ABSTRACT

An improved rotational tool bit used for operational engagement with a Phillips head style fastener that has alternating different height wings with alternating vertical and horizontal concavities, coupled with alternating grip geometric configurations at different heights on a hardened steel rotational tool bit. There is a bite edge and a bite corner formed on alternate bit wings that contact adjacent and alternate walls of the slots of a screw head, deforming the walls to create a grip for the bit. The design eliminates the four common slip planes from which Phillips head screw cam-out occurs.

### CLAIM FOR DOMESTIC PRIORITY

This application incorporates by reference and is a Continuation in Part of U.S. patent application Ser. No. 14/624,843 filed Feb. 18, 2015 and herein incorporates by reference all disclosed material and definitions therein.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general to tool bits, and more particularly to folding multi-tool or knife technology.

### BACKGROUND

Folding multi-tools, especially knives, are commonplace with the American handyman. Unfortunately, because of the miniaturization of the folding blades and the requirement for a generally planar, narrow profile, many of the tools only marginally work. Phillips screwdriver bits are generally the only folding blade that has a cylindrical shaft. However, because of spatial limitations the diameter of this shaft is usually less than that of the standardized No. 2 Phillips bit. As a result, while they do grab screw heads, they fail to grab the screw heads adequately.

In the way of further background, the Phillips style heads of mechanical fasteners were originally developed to simplify production assembly. At the time of their development, slotted head fasteners were the norm. Unfortunately, for automated screwdrivers on assembly lines, the torque 10 loads they could provide before cam-out were low. Additionally, the slip out encountered by slotted bits lead to dangerous situations. Besides providing an instant feel of correct fitting engagement, the four symmetrical wing design of Phillips style driver bits provided the following main mechanical features: the automatic centering of the bit into the fastener's top recess; the ability for the bit to hold the fastener thereon (either as magnetized or vertically positioned); the ability to force cam-out of the bit from the fastener once the threshold amount of rotational torque is reached; and to provide a bit-to-fastener engagement that allows for a significant increase in the amount of rotational torque that could be successfully applied to a conventional slotted head fastener. Today much of the production fasteners have been changed to one of the multi point recessed head systems or hexagonal head systems to allow even higher torque applications. Although the original Phillips style driver bit that matingly conformed to the Phillips style head geometry offered significant improvements over the existing prior art fastener systems, it also had several drawbacks. First, the amount of torque that could be applied was limited to the amount of contact force the user could maintain between the bit and the fastener, in opposition to the cam-out forces. Second, the fastener head recess or the bit wings would round and strip as the bit “camed-out” of the fastener and less of the bit wing and fastener recess were in contact with each other. This is a common occurrence with fasteners that self tighten in operation and require a reverse direction extraction torque beyond their initial installation torque.

Henceforth, an improved rotational tool bit adapted for use in a folding multi-tool that allowed for an increased torque application without stripping the screw head or “caming-out” would fulfill a long felt need in the multi-tool industry. This new invention utilizes and combines known and new technologies in a unique and novel configuration to overcome the aforementioned problems and accomplish this.

### BRIEF SUMMARY

In accordance with various embodiments, a planar profile folding blade adapted for use as a Phillips screw bit (“bit”) in a folding multi-tool that avoids cam-out under heavy torque applications is provided.

Various modifications and additions can be made to the embodiments discussed without departing from the scope of the invention. For example, while the embodiments described above refer to particular features, the scope of this invention also includes embodiments having different combinations of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a side perspective view of the bit;

FIG. 2 is a top side view of the bit;

FIG. 3 is a side view of the bit;

FIGS. 4 and 5 are a end cross sectional views through section line A-A of FIG. 3;

FIG. 6 is an end perspective view of the bit engaged in a Phillips screw head;

FIG. 7 is an enlarged view of the engagement of the bit from zone B of FIG. 6;

FIG. 8 is a linear cross sectional perspective view of the bit engaged in a Phillips screw head;

FIG. 9 is an enlarged view of the engagement of the bit from zone C of FIG. 8;

FIG. 10 is a cross sectional partial cut away view of a screw with the bit engaged in the screw head;

FIG. 11 is an enlarged view of the engagement of the bit from zone E of FIG. 10;

FIG. 12 is a side view of the bit engaged in a Phillips bit;

FIG. 13 is a cross sectional view of the bit and screw head through section line D-D of FIG. 12; and

FIG. 14 is a cross sectional view taken through the bit engaged in a screw head showing the bite line and bite corner.

### DETAILED DESCRIPTION OF CERTAIN EMBODIMENTS

While various aspects and features of certain embodiments have been summarized above, the following detailed description illustrates at least one exemplary embodiment in further detail to enable one skilled in the art to practice such an embodiment. The described example is provided for illustrative purposes and is not intended to limit the scope of the invention.

In the following description, for the purposes of explanation, numerous specific details are set forth in order to provide a thorough understanding of the described embodiment/s. It will be apparent to one skilled in the art, however, that other embodiments of the present invention may be practiced without some of these specific details. While various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The present invention relates to a novel design for a bladed tool bit that incorporates three physical mechanisms to increase the amount of torque that can be applied to the bit before cam-out occurs; a bi-level bite (at middle of slot head and top edge of slot head), a vertical concavity on all four wings and a horizontal concavity on two of the wings at 180 degrees apart. These establish an acute wing bite angle leading to a linear bite edge 32 and a bite corner 41.

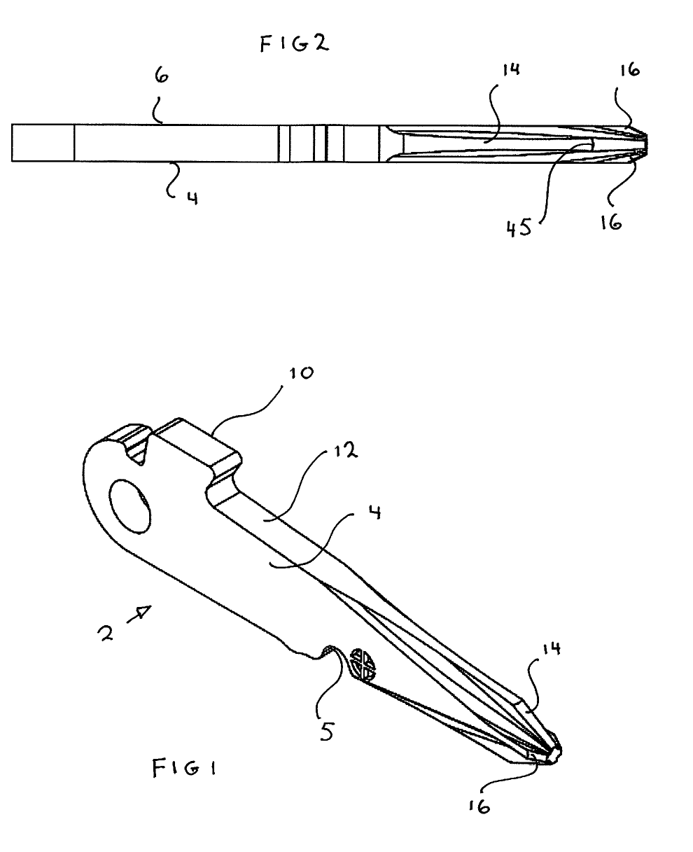

Looking at FIGS. 1-3 it can be seen that the bit 2 has a blade body made from a planar section of steel plate that is rectangular in axial cross section having a uniform thickness and a planar first side face 4 parallel to a planar second side face 6. There is a narrower top face 5 and a narrower bottom face 12 spanning between the two parallel side faces 4 and 6. There is a mounting orifice 8 formed between the two side faces at the distal end of the blade body as well as a stop tab 10 extending normally from its bottom face 12. These are for the rotational mounting of the bit 2 in a multi tool and for the proper resting position of the bit 2 in the multi tool when closed. At the proximal end of the blade body are formed four wings equally disposed at 90 radial degrees apart from all adjacent wings. Each wing has two side walls and a face spanning between the top edges of these side walls.

The wings alternate having two different heights. There is a pair of identical, first height (tall) wings 14 disposed 180 radial degrees apart, and a pair of identical, second height (short) wings 16, also disposed 180 degrees apart. In this fashion, each tall wing 14 is adjacent and equally spaced from two short wings 16, and each short wing 16 is adjacent and equally spaced from two tall wings 14. The tall wing faces spanning between the two tall wings are sections of the top face 5 and narrower bottom face 12 spanning between the two parallel side walls of the blade body. The short wing faces spanning between the two short wings are sections of the planar side faces 4 or 6 of the blade body.

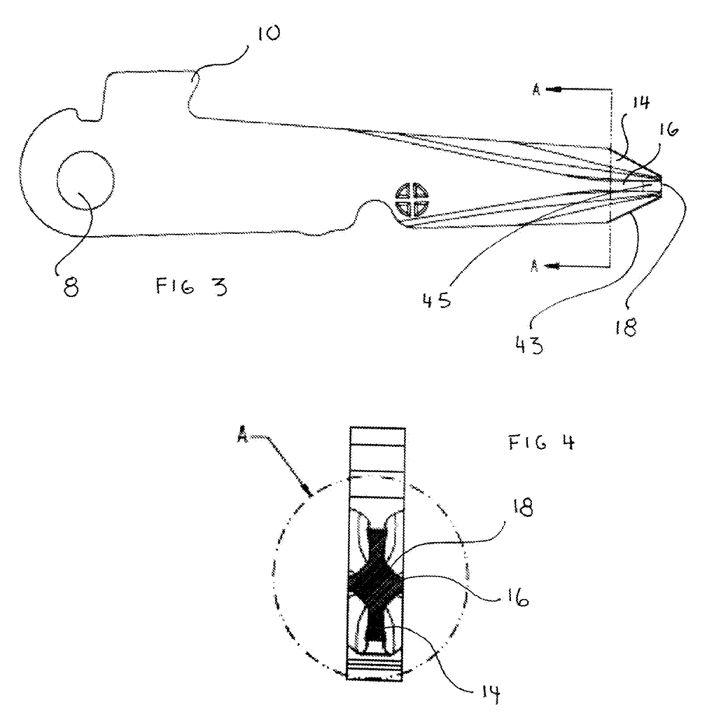

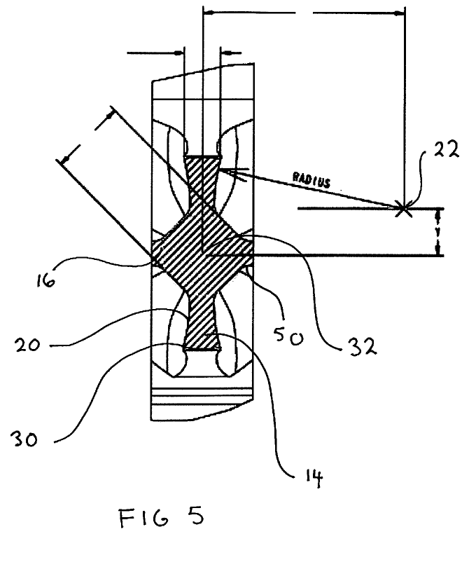

FIGS. 4 and 5 illustrate that in axial cross section of the bit tip through section A-A of FIG. 3 the wings extend different distances from the center 32 of the bit web 18. Since the four slots in the Phillips screw heads are identical in configuration and disposed at 90 radial degrees from each other, the tall wings 14 and short wings 16 will contact the walls of the four slots at different depths. Since there is some clearance in the thickness of the four wings and the thickness of the slot in the screw head, when the bit is twisted the tall wings 14 contact the top edge of the screw head and the corner of the short wings contact the walls of two of the slots approximately midpoint of the slot's depth. (See FIG. 9)

From FIG. 5 it can also be seen that side walls 20 of the tall wings 14 have concavity cut at a radius C from a point 22. The short wings 16 also have a concavity. These can be termed vertical concavities when viewed from the proximal end of the bit. It is to be noted that the tall wings 14 each have an identical height defined between the bit web 18 and the top or bottom faces 5 or 12.

The short wings 16 each have an identical height defined as the distance between the bit web 18 and the short wing faces (planar side faces 4 or 6). The side walls of the short wings 50 are also concave. The short wings 16 have a short tapered leading edge 45 at the proximal end of the bit 2. Similarly, the long wings 14 have a long tapered leading edge 43 on the top or bottom faces 5 or 12 at the proximal end of the bit 2. (FIG. 3)

The four wings of a conventional Phillips bit are all of the same height and are either straight or tapered but not concave. Thus, in rotational operation, the conventional bit has its straight or tapered wings in planar contact with the sides of the slots of the Phillips head screw. This forms four identical slip planes from which cam-out occurs. The torque applied to the screw head through the conventional bit is spread out across the surface area of this bit, onto the slip planes and as this torque is increased it reaches a limit where there is a low torque cam-out and the bit slides upward along the slip planes and out of the base 33 of the screw head recess 35.

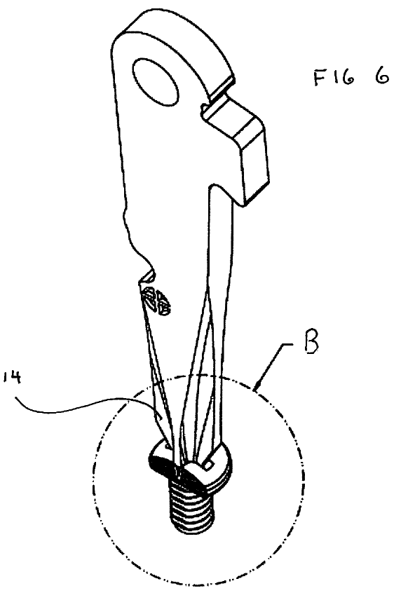

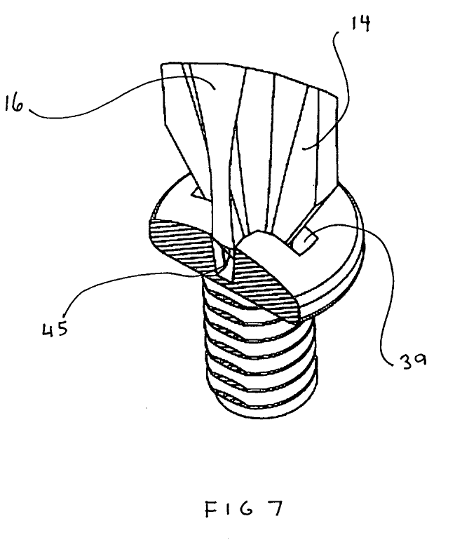

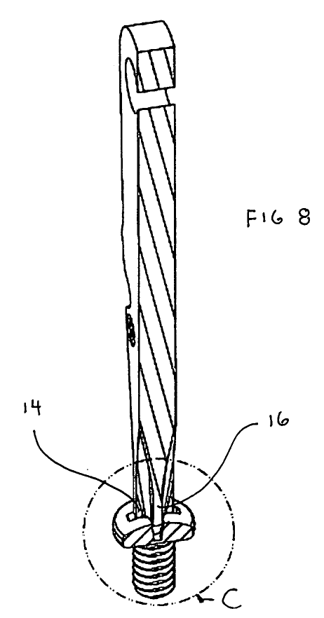

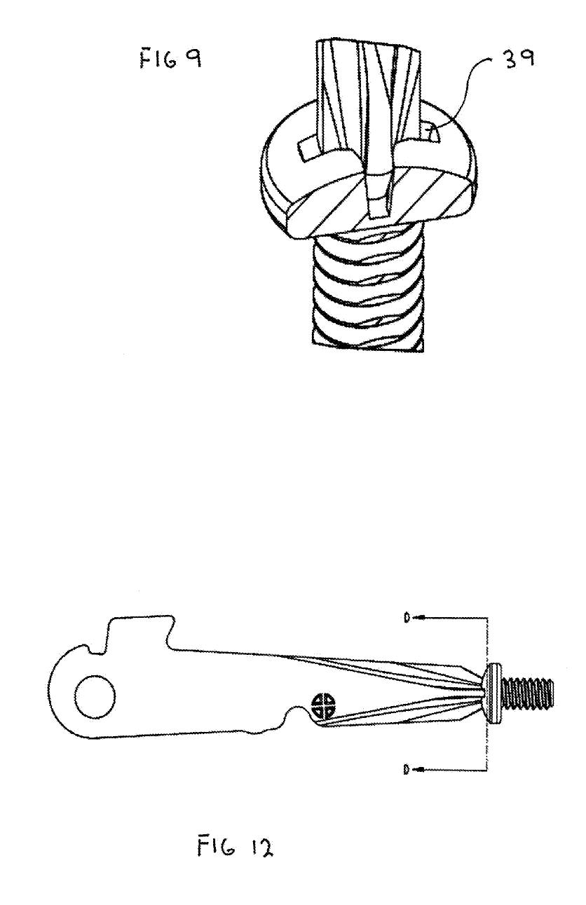

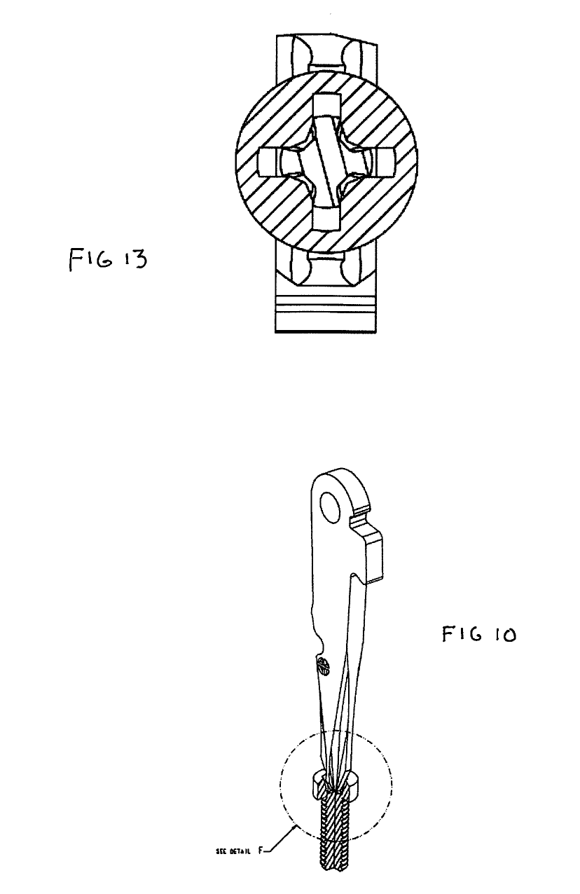

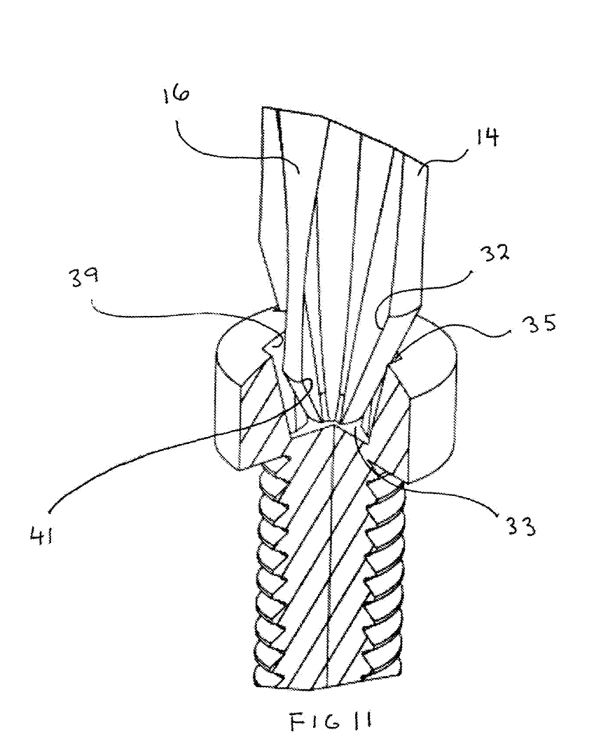

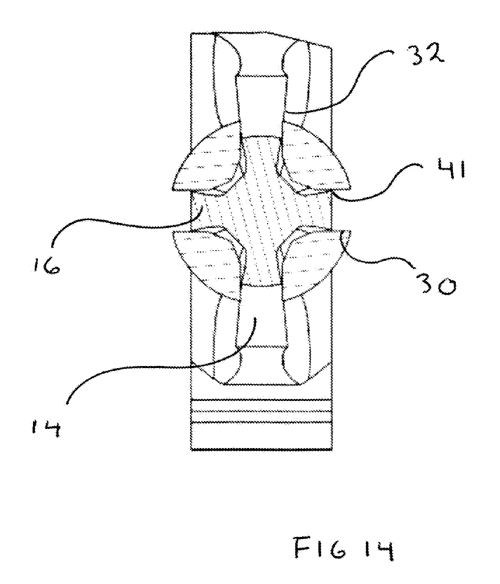

Looking at FIGS. 6-13 it can be seen that by cutting a concave wing configuration in the side wall of the tall wing 14, there is a linear bite edge 32 formed that runs along either side of the tall wings 14 at the acute angled intersection of the tall wing side walls 20 and the long tapered leading edge 43 on the top or bottom faces 5 or 12. Here the amount of surface area of the tall wings 14 that contacts the walls of the slots 39 of the Phillips head screw is greatly reduced over that of a conventional bit, and the contact point pressure applied to the walls of the slots 39 by the twisting motion is much higher per unit area. Since the bit 2 is mad of a hardened steel, (preferably on a hardness scale of Rockwell C-58 or greater) this high contact point pressure allows the linear bite edge 32 to deform the top of the screw head (where the walls of the screw slots meet the top face of the screw head) leaving an indentation for the bit to grab onto. As the metal is deformed the linear bite edge 32 then contacts the side wall of the slot and resists cam-out. Grip is increased dramatically. As more force is used, the indentation at the top of the screw head deepens such that the linear bide edge 32 may also deform two of the walls of the screw slots in a straight line, also enhancing the grip.

Turning our attention now to the short wings 16 it can be seen that these are cut in the wider first side face 4 and second side face 6. Here there actually exists an obtuse angle formed at the intersection of the short wing side walls and the short wing face. Rather, there is a concavity cut along the length of the face of the short wing 16 up to the distal edge of the short tapered leading edge 45. This is seen best in FIGS. 5 and 6 and can be termed a horizontal concavity as viewed from the proximal end of the bit. Thus the vertical concavity of the long wings 14 and the short wings 16 run perpendicular to the horizontal concavity of the short wings 16. These two concavities on the short wing 16 form a bite corner 41 on either side of the short wings 16 at the intersection of the short wing walls 20, the first side face 4 or second side face 6 and the distal edge of the short tapered leading edge 45. This bite corner 41 is low enough on the bit (close to the proximal end) to make a point contact with the approximate midpoint of the walls of the slots 30 of the screw head. Stated differently, the bite corner 41 occurs less than 0.034 mm from the actual proximal end of the blade body. (The minimum slot depth of a number 1 Phillips machine screw is 0.034 mm.) Similar to the linear bite edge 32, with applied twisting force, the bite corner 41 deforms and indents the soft walls of the slots 39 of the screw head leaving an indentation that the bit can grab onto and resist cam-out.

Looking at FIG. 14 the bite edge 32 of the tall wing 14, and the bite corner 41 of the short wing 16 can best bee seen in operation contacting the walls of the slots 30 of the screw head.

The overall design of alternating different height wings with alternating grip geometric configurations at different heights on a hardened steel rotational tool bit eliminates cam-out. In the preferred embodiment the wings have a maximum thickness of 0.046 inches, a minimum thickness of 0.034 inches having a depth of concavity of 0.017 inches per each side of each wing. Since the tall wing 14 and the short wing 16 are of different heights but have the same depth of concavity, the radius of their concavity is different. Although in different embodiments, and for ease of fabrication, it is known that the same radius of concavity may be used in all wings leaving a lesser depth of the concave face on the short wings 16.

With the bite edge 32 and the bite corner 41 contacting and deforming adjacent and alternate walls of the slots 39 of the screw head at different heights, there is a greatly reduced amount of surface contact between the bit and the screw head, an increased pressure per contact area, a stronger grip of the bit into the deformed/indented screw head walls, the elimination of four common slip planes for cam-out to occur from; and different applied torsional force lines onto the screw head. These mechanisms combined allow an enhanced grip by the bit of the Phillips head screw that overcomes the standard inclination for the bit to Cam-out. This enhanced gripping capability works with both clockwise and counter-clockwise applications.

While certain features and aspects have been described with respect to an exemplary embodiment, one skilled in the art will recognize that numerous modifications are possible. Components described according to a particular structural architecture may be organized in alternative structural architectures. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. It will be appreciated that the invention is intended to cover all modifications and equivalents within the scope of the following claims.

Having thus described the invention, what is claimed as new and desired to be secured by Letters Patent is as follows:

1. A rotational tool bit compatible with a Phillips head screw, comprising:
a blade body formed from a planar section of steel plate, said blade body having a distal end and a proximal end;
a pair of identical, first height tall wings formed at said proximal end of said blade body;
a pair of identical, second height short wings formed at said proximal end of said blade body;
wherein said tall wings and said short wings are alternately arranged at a 90 radial degree spacing, and
wherein said first height is greater than said second height.

2. The rotational tool bit of claim 1 wherein each of said tall wings have two of a first height side wall separated by a tall wing face, and wherein said short wings have two of a second height, non-concave, side wall separated by a short wing face.

3. The rotational tool bit of claim 2 further comprising a concavity cut into said first height side walls so as to create a vertical concavity.

4. The rotational tool bit of claim 3 further comprising:
a convex taper cut along said short wing faces so as to create a horizontal concavity.

5. The rotational tool bit of claim 4 further comprising:
a long tapered leading edge formed at the proximal end of said tall wing face;
a short leading tapered edge formed at the proximal end of said short wing face,
wherein said long tapered leading edge has a length that exceeds a length of said short tapered leading edge.

6. The rotational tool bit of claim 5 further comprising:
an obtuse angle formed at the intersection of said second height side wall and said short wing face so as to form a bite corner.

7. The rotational tool bit of claim 6 wherein said second height of said short wing at said bite corner is less than 0.034 mm.

8. The rotational tool bit of claim 7 further comprising:
an acute angle formed at the intersection of said first height side wall and said long wing face so as to form a linear bite edge.
